(19) United States
(12) Patent Application Publication
(10) Pub. No.: US 2006/0143709 A1
(43) Pub. Date: Jun. 29, 2006

(54) Network intrusion prevention

(75) Inventors: Randall S. Brooks, Tampa, FL (US); Matthew C. Rixon, Tampa, FL (US); Jonathan D. Goding, Tampa, FL (US)

Correspondence Address: BAKER BOTTS LLP, 2001 ROSS AVENUE, 6TH FLOOR, DALLAS, TX, 75201, US

(73) Assignee: Raytheon Company

(21) Appl. No.: 11/023,320

(22) Filed: Dec. 27, 2004

(51) Int. Cl. G06F 12/14

(52) U.S. Cl. 726/23

(57) ABSTRACT

According to one embodiment of the invention, a system for preventing a network attack is provided. The system includes a computer having a processor and a computer-readable medium. The system also includes a shield program stored in the computer-readable medium. The shield program is operable, when executed by the processor, to transmit an agent to each of one or more nodes in a network in response to an attack directed to the network. The agent is operable to initiate a reduction of the effect of the attack on the node.

### TECHNICAL FIELD OF THE INVENTION

This invention relates generally to network security and more particularly to network intrusion prevention.

### BACKGROUND OF THE INVENTION

An electronic attack using means such as a computer virus can disable a computer network, which may lead to a myriad of negative consequences. To avoid such results, devices such as firewalls and network intrusion detection systems are placed at different entry points of a network in an attempt to detect and block computer viruses at these entry points. However, these defense mechanisms may not be sufficiently effective against some viruses, such as a worm, that can spread quickly throughout the entire network.

### SUMMARY OF THE INVENTION

According to one embodiment, a system for preventing a network attack is provided. The system includes a computer having a processor and a computer-readable medium. The system also includes a shield program stored in the computer-readable medium. The shield program is operable, when executed by the processor, to transmit an agent to each of one or more nodes in a network in response to an attack directed to the network. The agent is operable to initiate a reduction of the effect of the attack on the node.

Some embodiments of the invention provide numerous technical advantages. Other embodiments may realize some, none, or all of these advantages. For example, according to one embodiment, a network intrusion prevention method and system are provided that can react faster to a network attack by transmitting a defense and/or offense mechanism to some or all nodes in a network. In another embodiment, efficiency and capability of a network intrusion prevention system are enhanced by placing a defense and/or offense mechanism at the end-host level. In another embodiment, alternative network intrusion prevention methods are provided by positioning a defense/offense mechanism at the end-host level and taking advantage of the relatively high number of end-host devices to launch an offensive operation against a source of an attack.

Other advantages may be readily ascertainable by those skilled in the art.

### BRIEF DESCRIPTION OF THE DRAWINGS

Reference is now made to the following description taken in conjunction with the accompanying drawings, wherein like reference numbers represent like parts, in which:

FIG. 1 is a schematic diagram illustrating one embodiment of a network environment that may benefit from the teachings of the present invention;

FIGS. 2 and 3 are schematic diagrams each illustrating one embodiment of an intrusion prevention architecture that may be used in the environment of FIG. 1;

FIG. 4 is a schematic diagram illustrating one embodiment of an assigned propagation of autonomous agents within the example architecture of FIG. 2 or FIG. 3;

FIG. 5 is a schematic diagram illustrating one embodiment of a propagation of autonomous agents to neighboring nodes within the example architecture of FIG. 2 or FIG. 3;

FIG. 6 is a logic flowchart showing address-based logic paths through which information about attacks directed to the network of FIG. 1 may be located;

FIG. 7 is a schematic diagram illustrating one embodiment of a graphic user interface that may be used in conjunction with the example architecture of FIG. 2 or FIG. 3; and

FIG. 8 is a flowchart illustrating one embodiment of a method of network intrusion prevention.

### DETAILED DESCRIPTION OF EXAMPLE EMBODIMENTS OF THE INVENTION

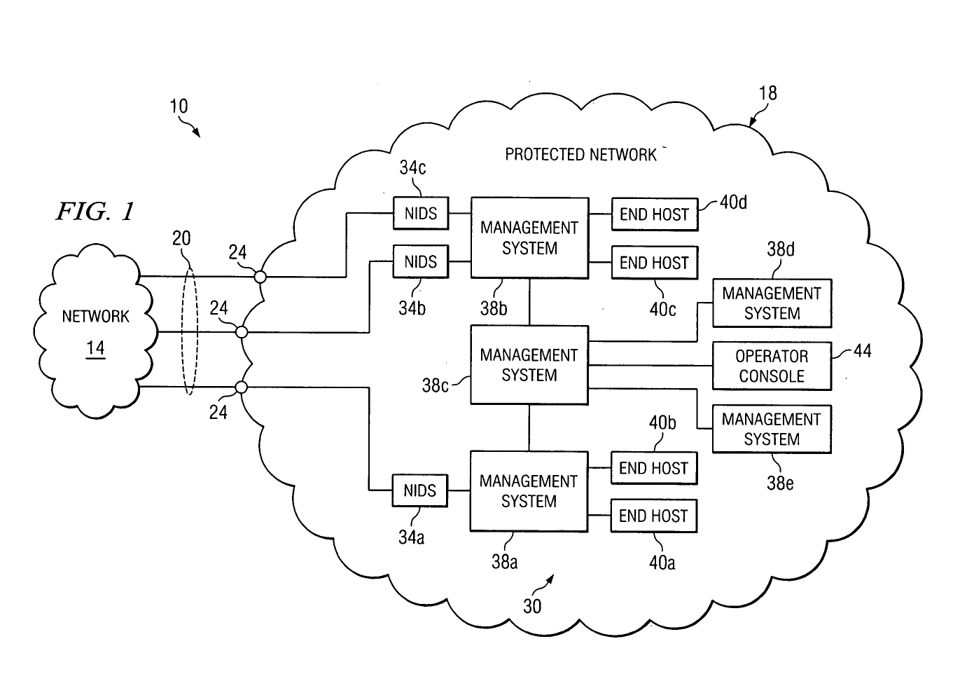

Embodiments of the invention are best understood by referring to FIGS. 1 through 8 of the drawings, like numerals being used for like and corresponding parts of the various drawings.

FIG. 1 is a schematic diagram illustrating one embodiment of a network environment 10 that may benefit from the teachings of the present invention. Environment 10 comprises a protected network 18 and a network 14. Networks 14 and 18 may communicate with each other over lines 20, which may be physical and/or logical communications paths. Protected network 18 communicates with network 14 and/or any other entity through entry points 24. Conventionally, a firewall may be placed at each entry point 24 to screen incoming data at entry points 24 and block some or all communications if an attack, such as a virus attack, is detected. However, because a firewall is responsible for one entry point 24, the use of a firewall may be ineffective when the attack occurs at other portions of network 18 and/or the firewall misses a virus or other form of attack and allows it to pass entry point 24. This may be especially problematic where the attack is a fast-spreading pathogen, such as a worm.

According to some embodiments, a network intrusion prevention method and system are provided that can react faster to a network attack by transmitting a defense and/or offense mechanism to many or all nodes in a network after an attack is detected. In some embodiments, efficiency and capability of a network intrusion prevention system are enhanced by placing a defense and/or offense mechanism at the end-host level. In other embodiments, alternative network prevention methods are provided by positioning a defense/offense mechanism at the end-host level and taking advantage of the relatively high number of end-host devices to launch an offensive operation against a source of an attack.

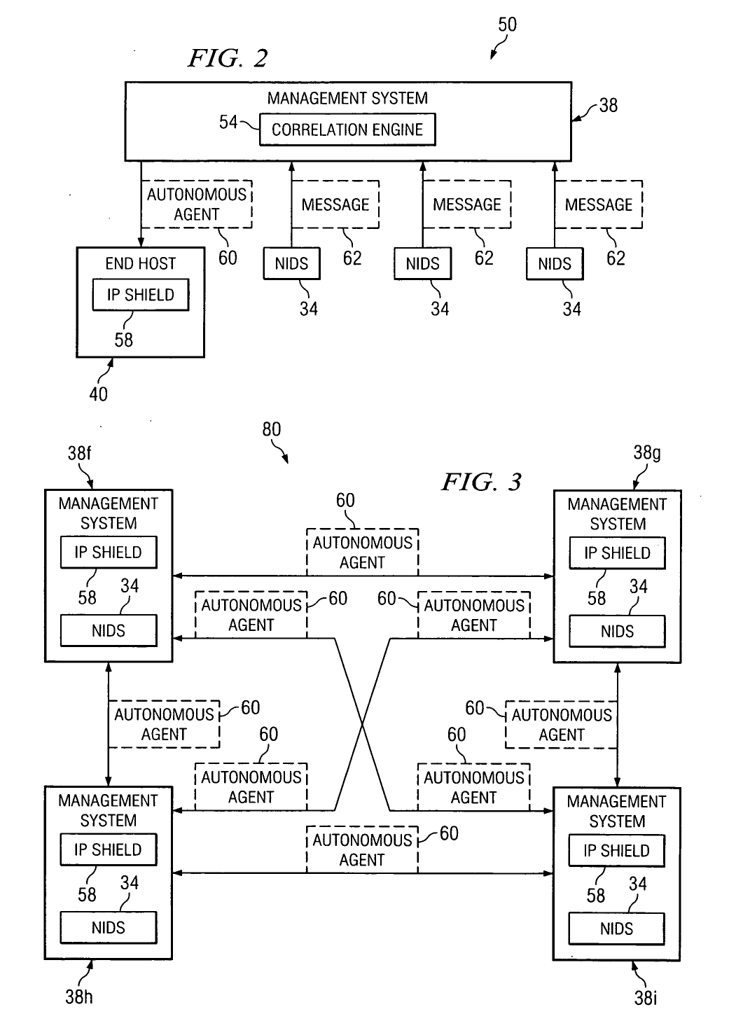

Referring back to FIG. 1, protected network 18 comprises a plurality of nodes 30. Nodes 30 comprises network intrusion detection systems (NIDS) 34a through 34c, management systems 38a through 38e, end-hosts 40a through 40d, and an operator console 44. NIDS 34a through 34c are collectively and/or generally referred to as NIDS 34, management systems 38a through 38e are collectively and/or generally referred to as management systems 38, and end hosts 40a through 40d are collectively and/or generally referred to as end hosts 40 or end host nodes 40. NIDS 34, management systems 38, and end host nodes 40 are communicably coupled so that end host 40 can communicate with nodes 30 within network 18 and nodes in other networks, such as network 14. Additional details concerning various architectures that may be used to configure nodes 30 for network intrusion prevention are provided below in conjunction with FIGS. 2 and 3.

NIDS 34 is operable to scan network traffic and determine whether the scanned traffic constitutes an intrusion into network 18. NIDS 34 is operable to transmit a message indicating that an attack directed to network 18 is occurring if an intrusion is suspected or detected. In some embodiments, NIDS 34 is positioned in network 18 at entry point 24 or between entry point 24 and nodes 38/40 that are to be protected so that it can be sampled. The logical zone where NIDS 34 may be positioned may also be referred to as a “boundary” of network 18. In some embodiments, NIDS 34 may be positioned in locations other than the boundary of network 18, such as a server farm, and may also be positioned in another node, such as management system 38. Examples of NIDS 34 include, but are not limited to, SNORT, Cisco IDS (CIDS), and SYMANTEC MANHUNT.

Management system 38 is operable to receive the message from NIDS 34, and in response generate and transmit an autonomous agent (not explicitly shown in FIG. 1) to end hosts 40 and/or other management systems 38. An autonomous agent indicates that an attack directed to network 18 is occurring. An autonomous agent may include an intrusion prevention mechanism, such as a computer program, that can be executed at each end host 40 to perform defensive/offensive functions. In some embodiments, management system 38 may customize an autonomous agent depending on the particular type attack as determined by management system 38. For example, management system 38 may not be able determine whether a particular activity constitutes an intrusion and in response transmit autonomous agents that are configured to ask other nodes whether they have any information concerning the particular activity. In some embodiments, the transmission of such an autonomous agent may be limited to a particular number per day so that the use of bandwidth for such inquiries is minimized. For example, a maximum of four transmissions of such an autonomous agent may be allowed for management system 38. In some embodiments, the intrusion prevention program may already be installed in each node 30, and the autonomous agent may function as a trigger that initiates the execution of the already-installed intrusion prevention program in each node 30. In such embodiments, the autonomous agent may not include the intrusion prevention mechanism because the mechanism has already been installed in each node 30, such as end hosts 40. This is advantageous in some embodiments because the bandwidth usage between nodes 30 is reduced. Management system 38 may include a correlation engine (not explicitly shown in FIG. 1) that is operable to determine an identity of the attacker based on information received from one or more NIDS 34. An example identity of an attacker includes, but is not limited to, an IP address of the attacker. In some embodiments, the determined identity of an attacker may be included in an autonomous agent that is transmitted to other nodes 30.

End host 40 is a computing platform that allows a user to communicate network traffic with other nodes within and without network 18. End host 40 is also operable to store data. An example of end host 40 includes, but is not limited to, a desktop computer and a laptop computer. Operator console 44 is a computing platform that allows an operator to monitor network activity, including attacks, and take any suitable actions to protect network 18. Operator console 44 is operable to store data, including data concerning attacks against network 18.

Although FIG. 1 shows NIDS 34, management systems 38, and end hosts 40 at separate nodes 30, in some embodiments, a NIDS 34, a management system 38, and an end host 40 may be combined into one node 30 that performs the functions of all three nodes 34, 38, and 40.

FIG. 2 is a schematic diagram illustrating an example of an intrusion prevention architecture 50 that may be used in network 18 shown in FIG. 1. Architecture 50 comprises management system 38, NIDS 34, and end host 40. NIDS 34 are communicably coupled with management system 38, and management system 38 is communicably coupled with end host 40.

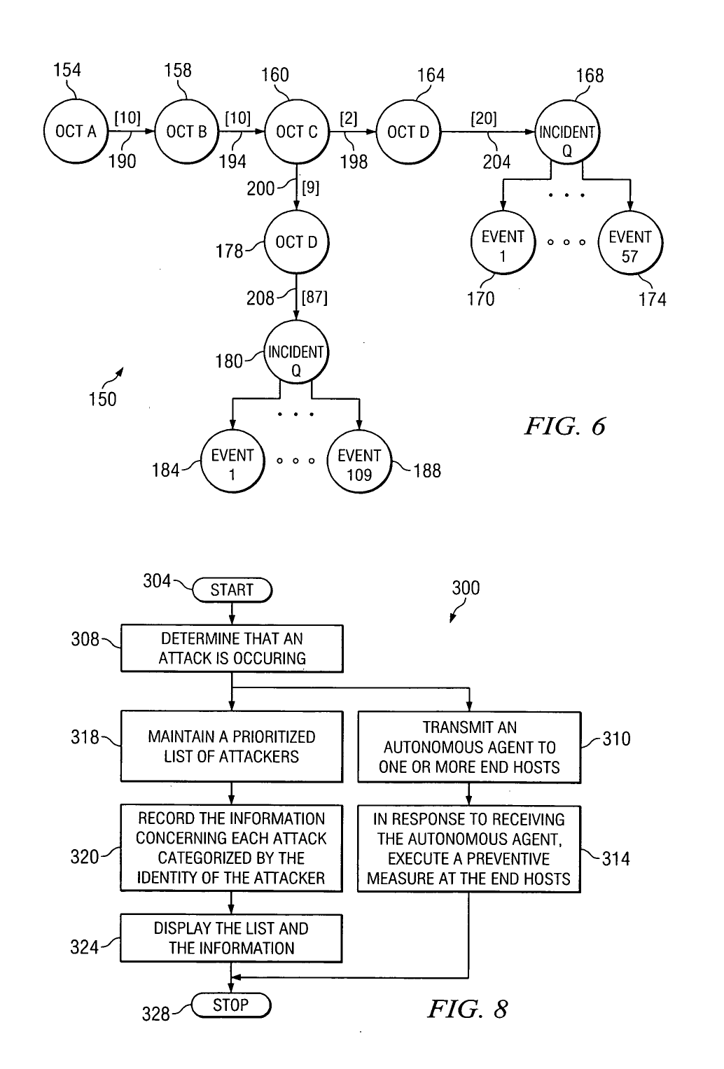

Management system 38 comprises a correlation engine 54 that is operable to recognize patterns from different attack signatures and draw conclusions regarding a particular attack, such as an identity of an attacker. Correlation engine 54 may also be used to store data concerning attacks. Additional details concerning the storage and location of attack information are provided below in conjunction with FIG. 6. In some embodiments, correlation engine 54 may be operable to determine a threshold of aggregated attack levels that will trigger the transmission of autonomous agent 60. This autonomous agent 60 may instruct end host 40 to block the specified attacker IP address and port for a specified amount of time.

End host 40 comprises an intrusion prevention shield program 58 that is operable to perform defensive and/or offensive functions according to the instructions in autonomous agent 60. Shield program 58 is also operable to receive and/or execute a prevention program that may be included in autonomous agent 60 or pre-installed in end host 40. In some embodiments, shield program 58 is a computer program. In an embodiment where the prevention program is already installed in end host 40, autonomous agent 60 does not include the prevention program. Thus, shield program 58 is operable to receive autonomous agent 60 and in response initiate an execution of the already-installed prevention program. In some embodiments, this is advantageous because less bandwidth is required between management system 38 and end host 40 to trigger the execution of prevention acts at the end-host level.

The prevention program and shield program 58 may be operable to perform different types of defensive and offensive acts for a predetermined period of time. An example of a defensive measure is to stop communicating with the attacker identified by autonomous agent 60. In some embodiments, the prevention program and/or shield program 58 may also be operable to stop communication with the identified attackers and other entities that are suspected of being an attacker. Other defensive responses include, but are not limited to, logging (logs data flow from the attacker), dropped packets/shunning (denial of a particular IP address and port, which could be triggered from a passed signature from management system 38), TCP resets (disallowance of communication with IP address and port), network interface card shutdown (if the attacker is an Advanced Intrusion Prevention-managed system), sandbox of attack (the use of a sandbox to intercept the IP connection, execute/check for validity, and if valid, allow the connection to execute), and proxy to honey pot (if the IP address is suspicious, redirect the connection to a honey pot).

Examples of offensive measures include, but are not limited to, pinging, TCP synchronization/finish/acknowledgement, exercising of a known vulnerability of the attacker (learned through logging, for example), sending a constant UDP stream, constantly initiating NetBios session connection requests, and any other DDOS attacks. In some embodiments, one or more of these measures can be implemented as a counterattack in response to an attack. In cases where the attacker is determined to have a shield program 58, management system 30 may initiate a shutdown of the attacker's network interface card. Because many or all of nodes 30 are involved in an offense to flood an attacker with pings and other signals, some embodiments of the present invention may be used not only to block attacks from an attacker, but also to disable the attacker.

In operation, one or more NIDS 34 may detect an intrusion and transmit an alert message 62 to management system 34. Correlation engine 34 of management system 38 analyzes the information in alert message 62, reaches certain conclusions about the attack (e.g. the type of computer virus detected, the identity of the attacker, a history of similar/identical attacks, etc), and transmits autonomous agent 60 that includes some or all of the determined information to one or more end hosts 40. Autonomous agent 60 may also include instructions on what type of defensive/offensive functions should be performed. In some embodiments, autonomous agent 60 may be communicated between nodes 30 with the use of SSL. SSL provides encryption and digital signatures for integrity of autonomous agent 60.

In response to receiving autonomous agent 60, shield program 58 of end host 40 performs one or more prevention acts at end host 40. In some embodiments where the prevention program is already installed in end host 40, shield program 58 executes the prevention program in response to receiving autonomous agent 60. In some embodiments where the prevention program is not already installed in end host 40, shield program 58 receives the prevention program as a part of autonomous agent 60 and installs the prevention program. Then shield program 58 initiates an execution of the preventive program so that one or more prevention acts can be performed by end host 40. End host 40 may send autonomous agent 60 to other end hosts 40. End host 40 may also send autonomous agent 60 to management system 38 if requested by management system 38.

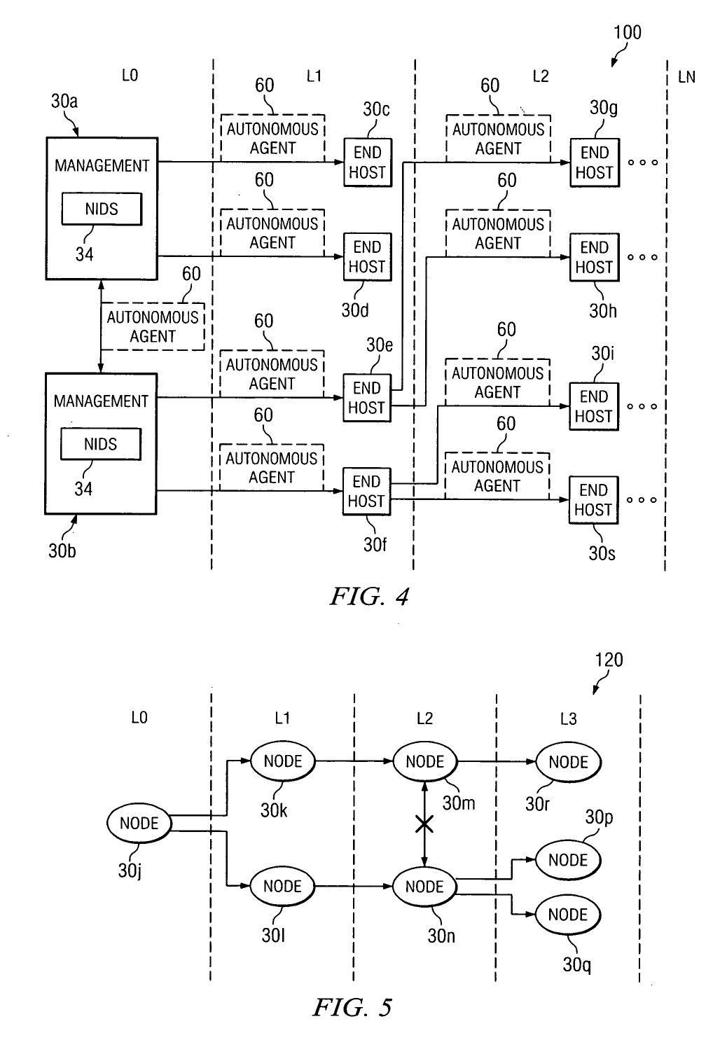

FIG. 3 is a schematic diagram illustrating an example of an intrusion prevention architecture 80. Architecture 80 comprises management systems 38f through 38i, and each one of management systems 38f through 38i comprises shield program 58 and NIDS 34. In an architecture such as architecture 80 shown in FIG. 3, nodes 30 such as nodes 30f through 38i are operable to detect an intrusion directed to network 18 and send autonomous agent 60 to other nodes 30. For example, management system 38f shown in FIG. 3 may detect an intrusion using NIDS 34 and in response transmit autonomous agent 60 to management systems 38g, 38h, and 38i. In response to receiving autonomous agent 60, management systems 38g, 38h, and 38i each transmits autonomous agent 60 to one or more other nodes 30. The other nodes 30 in turn each transmits autonomous agents 60 to other nodes 30 that have not received autonomous agent 60. The transmission of agent 60 may continue this way until all nodes 30 receive autonomous agent 60. Any other management system 38, such as management system 38g, may detect a network intrusion and start an analogous chain distribution of autonomous agent 60. In response to receiving autonomous agent 60, each of management systems 38g, 38h, 38i, and other nodes 30 that receive autonomous agent 60 may also execute a protection program that may have already been installed. For example, shield program 58 of management system 38g receives autonomous agent 60 and in response executes the already-installed protection program. In some embodiments where the protection program is not installed in management systems 38f through 38i, autonomous agent 60 includes the protection program for installation and execution by respective shield programs 58 of management systems 38f through 38i. In embodiments such as the one shown in FIG. 4, management systems 38 may constitute the “end hosts” or the “end-host level.” Because management systems 38 of the embodiment shown in FIG. 4 can also perform the functions of NIDS 34, the functions of NIDS 34 are not necessarily performed at the boundary of network 18, in some embodiments. Autonomous agent 60 may be transmitted to some or all nodes 30 of protected network 18 through a variety of distribution plans. Example plans for transmitting autonomous agent 60 to a portion or all of network 18 are described below in conjunction with FIGS. 4 and 5.

FIG. 4 is a schematic diagram illustrating one embodiment of an assigned propagation plan 100 that may be used to transmit autonomous agent 60 to some or all nodes 30 shown in FIG. 1. Architecture 100 assumes that “level zero” (shown as “L0” in FIG. 4) is where the intrusion is first detected. As an example, a node 30a may detect an intrusion using NIDS 34. Upon detecting the intrusion, node 30a transmits autonomous agent 60 to a node 30b, which is in the same level zero. Node 30a may also transmit autonomous agent 60 to nodes 30c and 30d in level one (shown as “L1” in FIG. 4) after detecting the intrusion. After receiving autonomous agents 60, nodes 30c and 30d may transmit autonomous agents to other assigned nodes 30.

After receiving autonomous agent 60 from node 30a, node 30b is operable to transmit autonomous agents 60 to nodes 30e and 30f in level one. After receiving autonomous agent 60, node 30e transmits autonomous agents 60 to nodes 30g and 30h in level two, shown in FIG. 2 as “L2.” After receiving autonomous agent 60, node 30f transmits autonomous agent 60 to nodes 30i and 30s in level two. Although plan 100 shows each node 30 sending autonomous agents 60 to two other nodes 30 in response to receiving an autonomous agent 60, any number of nodes 30 may be the recipient of autonomous agent 60. For example, node 30b may transmit autonomous agents 60 to one, two, three or more nodes 30 in level one. Although only three levels are shown in FIG. 4, any number of levels may exist depending on the number of nodes and the particular architecture of protected network 18 (as indicated by level N, shown as “LN” in FIG. 4). By assigning each node 30 to send autonomous agent 60 to one or more other nodes 30 in response to receiving autonomous agent 60, the number of nodes 30 that are made aware of an attack directed to network 18 increases exponentially and quickly, which allows a timely response to viruses such as a worm. In some embodiments, all nodes 30 in network 18 may be informed using the chain distribution of autonomous agent 60. In some embodiments, only those nodes 30 that are determined to be vulnerable to a particular attack may be informed using the chain distribution of autonomous agent 60.

FIG. 5 is a schematic diagram illustrating one embodiment of a propagation plan 120 of autonomous agent 60 to neighboring nodes 30. Rather than programming each node 30 with assignments for transmitting an autonomous agent, in some embodiments such as the one shown in FIG. 5, nodes 30 may be programmed to send an autonomous agent to each node 30 in a next level that it is able to communicate with. For example, node 30j, which is in level zero, detects an intrusion and transmits autonomous agents to nodes 30k and 30l in level one. Node 30j transmits autonomous agents to nodes 30k and 30l because node 30j has an already established communication path with nodes 30k and 30l. In response to receiving an autonomous agent from node 30j, node 30k transmits an autonomous agent to node 30m in level two. Node 30l in level one, in response to receiving an autonomous agent from node 30j, transmits an autonomous agent to node 30n in level two. In some embodiments, node 30m may have an established communications path with 30n, which is a node that is on the same level as node 30m, but such a transmission is either prevented, or the receiving node—node 30n in this case—simply ignores the autonomous agent because it is transmitted by another node in the same level. Such a rule may be implemented in order to reduce the level of duplicate communications between nodes 30, which reduces the level of bandwidth usage.

After receiving an autonomous agent from node 30k, node 30m transmits an autonomous agent to node 30r. In response to receiving an autonomous agent from node 30l, node 30n transmits autonomous agents to both nodes 30p and 30q in level three because node 30n has established communication paths with both nodes 30p and 30q. Plan 120 may be used with both architectures 50 and 80 shown in FIGS. 2 and 3, respectively. Plans 100 and 120 respectively shown in FIGS. 4 and 5 are particularly advantageous for wireless environments where one node 30 may be attacked but another node 30 in the same network may not be aware of the attack.

One or more nodes 30 may also be programmed with an “all mode,” which is a mode in which one or more nodes 30 broadcast or multicast autonomous agent 60 to all other nodes 30 within each subnet or within the entire network 18. Such a mode may be triggered if one node 30 cannot communicate with some or all other nodes 30 that the one node 30 is supposed to communicate with—either by assignment or a pre-existing relationship. For example, referring again to FIG. 4, if node 30e is unable to communicate with both nodes 30g and 30h for some reason (nodes 30g and 30h are both infected or otherwise disabled or inoperative, for example), then node 30e may go into the “all mode” and make one or more attempts to broadcast autonomous agent 60 to all nodes 30 within its subnet. Such a mode ensures that the autonomous agents are disseminated to as many nodes 30 within network 18 as possible even when one or more nodes 30 are disabled due to a technical problem or an infection.

FIG. 6 is a logic flowchart showing address-based logic map 150 that may be used to locate information about attacks directed to network 18 of FIG. 1. Each circle in FIG. 6 represents a junction from which a decision or a choice is made. Each arrow in FIG. 6 represents a decision path leading from one junction to a next junction. Logic map 150 is laid out so that information concerning one or more attacks are located in a data structure so that portions of an identity of the attacker may be used to traverse from one junction to the next junction until the appropriate information is found. Logic map 150 is described using an example scenario where two attackers having respective IP addresses “10.10.2.20” and “10.10.9.87” have a history of attacks on network 18. The example also assumes that attacker “10.10.2.20” executed 57 attacks on network 18, and the information concerning the 57 attacks were sent to management system 38. In the same example scenario, attacker “10.10.9.87” is assumed to have executed 109 attacks on network 18, and the information concerning the 109 attacks were sent to management system 38. Data may be stored and found in accordance with logic map 150 using correlation engine 54 of management system 38 shown in FIG. 2.

At a junction 154, octet A of an attacker's IP address is examined to determine which path should be taken. Because an attacker's attack information is located using the attacker's IP address, each path is selected based on a portion of the attacker's IP address. In this example, both attackers “10.10.2.20” and “10.10.9.87” have “10” as octet A. Thus, a path 190 corresponding to octet A value of “10” is followed. However, if octet A were a different value, such as any number between 1 through 9 or 11 through 255, then a different path corresponding to the particular value may be taken to another junction. At a junction 158, octet B of the attacker's address is examined. In this example, both attackers “10.10.2.20” and “10.10.9.87” have an octet B value of “10.” Thus, a path 154 is taken to junction 160. At junction 160, octet C is examined. In this example, attacker “10.10.2.20” has an octet C value of “2,” and thus a search for information associated with “10.10.2.20” follows a path 198 to a junction 164 where octet D of “10.10.2.20” is examined. Because attacker “10.10.2.20” has an octet D value of “20,” a path 204 is followed to an incident queue 168, where information concerning attack events 170 through 174 associated with the IP address of “10.10.2.20” is found.

Referring back to junction 160, because attacker “10.10.9.87” has an octet C value of “9,” a search for information concerning “10.10.9.87” follows a path 200 to a junction 178 where an octet D value of the attacker's address is determined. Because attacker “10.10.9.87” has an octet D value of “87,” a path 208 is followed to an incident queue 180, where information concerning attack events 184 through 188 associated with the IP address of “10.10.9.87” is found. Storing information concerning attacks based on the octet values of an IP address of an attacker is advantageous in some embodiments because locating and storing the information are made more efficient.

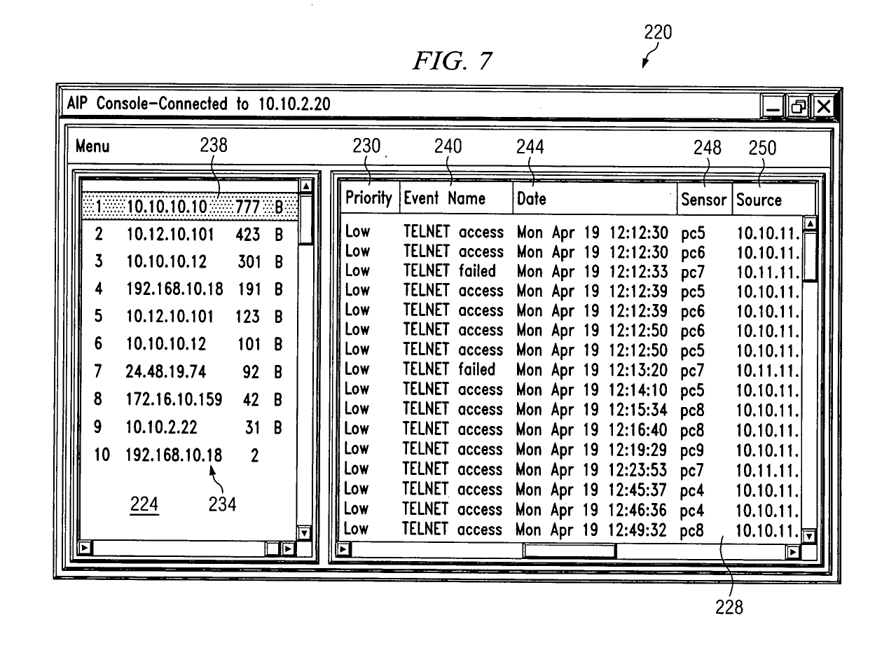

FIG. 7 is a schematic diagram illustrating a graphic user interface (GUI) 220 that may be displayed at an operator console, such as console 44 shown in FIG. 1, to allow an operator to maintain network situation awareness. In some embodiments, GUI 220 displays identities of attackers that may require immediate attention by an operator. Such a display may give the operator the ability to react to critical incidents, which may lower the level of damage to a protected network.

GUI 220 comprises a panel 224 and a panel 228. Panel 224 displays a list 234 of attacker addresses, and panel 228 comprises information concerning the highlighted attacker 238. For example, as shown in FIG. 7, address “10.10.10.10.” is highlighted and is identified using reference number 238. Because the operator selected this address, all of the information shown in panel 228 correlates to the highlighted address. The list of attacker address may also be prioritized so that the worst attacker is listed first. For example, attacker “10.10.10.10” is the worst offender, attacker “10.12.10.101” is the second worst offender, and so forth.

The information displayed in pane 228 is organized into columns. A column 230 indicates a particular priority level for each attack event. A column 240 shows an event name, which, in this example, is “TELNET”. A column 244 lists the date and time of each attack. A column 248 identifies a particular node 30 that detected the attack. A column 250 lists the identity of the attacker for each attack. In some embodiments, all attack information for each selected address shown in pane 224 may be located using logic map 150 shown in FIG. 6. However, any suitable method may be used to store and locate attack information for each identified attacker. Although one example of displaying information concerning a particular attacker and the associated attacks is shown using GUI 220 of FIG. 7, any suitable layout may be used.

FIG. 8 is a flowchart illustrating one embodiment of a method 300 for preventing intrusion of a network, such as network 18 shown in FIG. 1. Some or all acts of method 300 may be implemented using example architectures 50 and 80 shown in FIGS. 2 and 3, respectively. However, any suitable device or combination of devices may be used to implement method 300. Network 18, nodes 30, and architectures 50 and 80 shown in FIGS. 1, 2 and 3 are used as examples to describe some embodiments of method 300. However, the implementation of method 300 is not limited to the description provided below.

Method 300 starts at step 304. At step 308, a node 30 determines that an attack directed to network 18 is occurring. The node 30 of step 308 may be a NIDS 34 or a management system 38 that has an intrusion detection capability. An example of such a management system 38 is management system 38f shown in FIG. 3. At step 310, autonomous agent 60 is sent to one or more end hosts 40 and/or one or more management systems 38. In response to receiving autonomous agent 60, at step 314, end host 40 and/or management system 38 that received autonomous agent 60 executes a defensive and/or an offensive action. In some embodiments, management system 38 may also transmit autonomous agents 60 to other end hosts 40 and/or management systems 38. In some embodiments, propagation plans 100 and 120 shown in FIGS. 4 and 5, respectively, may be used to conduct the chain distribution.

At step 318, correlation engine 54 of management system 38 may maintain a prioritized list of attackers based on the severity of attacks. At step 320, information concerning each attack may be categorized by the identity of the attacker, as described in conjunction with FIG. 6. However, any suitable storage method may be used. At step 324, an attacker list and information concerning attacks associated with each attacker may be displayed using a suitable operator console, such as console 44, and may be displayed in a format shown in FIG. 7. Method 300 stops at step 328.

Although some embodiments of the present invention have been described in detail, it should be understood that various changes, substitutions, and alterations can be made hereto without departing from the spirit and scope of the invention as defined by the appended claims.

What is claimed is:

1. A method for preventing a network attack, comprising:
determining, at a management system, that an attack directed to one or more nodes of a network is occurring;
in response to the determination, transmitting an agent from the management system to each of the nodes;
in response to receiving the agent at each of the nodes, executing a program at each of the nodes, the program, when executed, operable to reduce the effect of the attack on the node.

2. The method of claim 1, wherein the one or more nodes are end host nodes each configured to be directly used by a user.

3. The method of claim 1, wherein the agent comprises the program, and further comprising installing the program in each of the nodes after receiving the agent.

4. The method of claim 1, wherein the one or more nodes comprises all of the nodes in the network.

5. The method of claim 1, and further comprising determining an identity of a source of the attack using the management system, wherein the agent includes the determined identity.

6. The method of claim 5, wherein the program is operable to halt the node executing the program from receiving network traffic from the identified source of the attack.

7. The method of claim 5, wherein the program is operable to conduct an offensive operation against the source of the attack by sending a signal to the source of the attack using the determined identity.

8. The method of claim 7, wherein the offensive operation comprises pinging the source of the attack.

9. The method of claim 5, wherein the source of the attack comprises a particular node in the network, the particular node comprising a network interface card, and wherein the program is operable to disable the network interface card of the particular node.

10. The method of claim 1, wherein the one or more nodes comprise one or more first management systems each operable to perform intrusion detection, and further comprising:
in response to receiving the agent at each first management system, transmitting the agent from each first management system to a plurality of second management systems each operable to perform intrusion detection; and
in response to receiving the agent at each second management system, transmitting the agent from each second management system to a plurality of third management systems each operable to perform intrusion detection, wherein the second and the third management systems are in the network.

11. The method of claim 1, and further comprising transmitting the agent to two or more other nodes in the network from the each node that received the agent.

12. The method of claim 1, and further comprising:
determining an address of a source of the attack; and
storing information describing the attack in the management system at a memory location that is reachable by following a plurality of logic steps, each logic step leading to a next logic step based on a particular portion of the address.

13. The method of claim 12, wherein the address comprises a plurality of numbers grouped in a plurality of octets, and the particular portion of the address comprises a particular octet.

14. The method of claim 1, wherein the nodes are end host nodes, and wherein transmitting an agent from the management system to each of the end host nodes comprises transmitting an agent to each of the end host nodes and to no other end host nodes in the network.

15. A system for preventing a network attack, comprising:
an intrusion detection device operable to detect an attack directed to a network and transmit a message indicating the detection of the attack;
a management system coupled to the intrusion detection device, the management system operable to receive the message and transmit one or more agents in response to receiving the message; and
an end host node coupled to the management system, the end host node operable to receive the agent and execute a program in response to receiving the agent, the program operable to reduce the effect of the attack on the end host node.

16. The system of claim 15, wherein the agent comprises the program, and wherein the end host node is further operable to install the program after receiving the agent, and then execute the program.

17. The system of claim 15, wherein the management system is operable to determine an identity of a source of the attack, and wherein the agent includes the determined identity.

18. The system of claim 17, wherein the program is further operable to halt the end host node from receiving network traffic from the identified source of the attack.

19. The system of claim 17, and further comprising a plurality of other end host nodes each operable to receive the agent and execute the program, and wherein the program is further operable to conduct an offensive operation against the source of the attack by transmitting a signal to the source of the attack in coordination with the other end host nodes.

20. The system of claim 19, wherein the offensive operation comprises pinging the source of the attack.

21. The system of claim 17, wherein the source of the attack comprises a particular node in the network, the particular node comprising a network interface card, and wherein the program is further operable to disable the network interface card of the particular node.

22. The system of claim 15, wherein the management system is further operable to:
determine an address of a source of the attack; and
store information describing the attack a memory location that is reachable by following a plurality of logic steps, each logic step leading to a next logic step based on a particular portion of the address.

23. The system of claim 22, wherein the address comprises a plurality of numbers grouped in a plurality of octets, and the particular portion of the address comprises a particular octet.

24. A system for preventing a network attack, comprising:
a computer having a processor and a computer-readable medium; and
a shield program stored in the computer-readable medium, the shield program operable, when executed by the processor, to transmit an agent to each of one or more nodes in a network in response to an attack directed to the network, the agent operable to initiate a reduction of the effect of the attack on the node.

25. The system of claim 24, wherein the one or more nodes are end host nodes each configured to be directly used by a user.

26. The system of claim 24, wherein the agent comprises a program operable to reduce the effect of the attack on the node executing the program, and further comprising a plurality of end host nodes coupled to the computer, each end host node operable to receive the agent and to install the program after receiving the agent.

27. The system of claim 24, and further comprising a plurality of nodes coupled to the computer, each node operable to detect a network intrusion, to receive the agent, to transmit the agent to a plurality of other nodes in the network in response to receiving the agent from the computer, and to launch a counterattack against a source of the attack in response to receiving the agent.

28. The system of claim 24, wherein the computer further comprises a correlation engine operable to determine an identity of a source of the attack, and wherein the agent includes the determined identity.

29. The system of claim 28, and further comprising a program stored in the computer-readable medium and operable to halt the computer from receiving network traffic from the identified source of the attack.

30. The system of claim 29, wherein the program is operable to conduct an offensive operation against the source of the attack by sending a signal to the source of the attack.

31. The system of claim 30, wherein the offensive operation comprises pinging the source of the attack.

32. The system of claim 24, wherein the computer further comprises a correlation engine operable to:
determine an address of a source of the attack; and
store information describing the attack in the computer at a memory location of the computer-readable medium that is reachable by following a plurality of logic steps, each logic step leading to a next logic step based on a particular portion of the address.

33. The method of claim 32, wherein the address comprises a plurality of numbers grouped in a plurality of octets, and the particular portion of the address comprises a particular octet.

34. A system for preventing a network attack, comprising:
a plurality of intrusion detection devices logically positioned approximately at a boundary of a network, each intrusion detection device operable to detect an attack directed to the network and transmit a message describing the attack;
a management system coupled to the intrusion detection devices, the management system operable to receive the message, determine an identity of a source of the attack, and transmit one or more autonomous agents; and
a plurality of end host nodes coupled to the management system, each end host node operable to receive a particular autonomous agent and execute a program in response to receiving the autonomous agent, the program operable to halt the receipt of network traffic from the source of the attack and launch an attack against the source of the attack by transmitting a signal to the source of the attack.

35. The system of claim 34, wherein the autonomous agent includes the program.

36. The system of claim 34, wherein the program is installed in each end host node prior to the detection of the attack by the intrusion detection devices.

37. The system of claim 34, wherein the end host node is a computer configured to be used directly by a user.

38. A system for preventing a network attack, comprising:
a plurality of management systems forming a network, each management system having a processor and a computer-readable medium, each management system operable to:
detect an attack directed to the network;
identify a first attacker that initiated the attack;
generate a first autonomous agent identifying the first attacker; and
transmit the first autonomous agent to one or more other management systems in the network;
an intrusion shield program stored in the computer-readable medium, the advanced intrusion shield program operable, when executed by the processor, to:
receive, from another management system, a second autonomous agent identifying a second attacker;
transmit the second autonomous agent to a plurality of other management systems in the network but not to the another management system from which the second autonomous agent is received; and
initiate an execution of a prevention program by the processor in response to receiving the second autonomous agent, the prevention program stored in the computer-readable medium and operable, when executed, to:
halt the receipt of network traffic from the second attacker; and
launch a counterattack against the identified second attacker by transmitting at least one signal to the second attacker.
